(19) United States
(12) Patent Application Publication
(10) Pub. No.: US 2024/0340802 A1
(43) Pub. Date: Oct. 10, 2024

(54) NETWORK DEVICE WITH MAINS-INDEPENDENT POWER SOURCE AND PROVIDING STATUS OF / ADAPTING OPERATION PROCEDURE DEPENDENT ON STATUS OF MAINS-INDEPENDENT POWER SOURCE

(71) Applicant: Fraunhofer-Gesellschaft zur Förderung der angewandten Forschung e.V., München (DE)

(72) Inventors: Julian POPP, Erlangen (DE); Baris GÖKTEPE, Berlin (DE); Thomas FEHRENBACH, Berlin (DE); Thomas WIRTH, Berlin (DE); Gustavo Wagner OLIVEIRA DA COSTA, Erlangen (DE); Thomas SCHIERL, Berlin (DE); Cornelius HELLGE, Berlin (DE); Clemens KORN, Erlangen (DE); Tobias DRÄGER, Erlangen (DE); Peter SPIES, Erlangen (DE); Josef BERNHARD, Erlangen (DE)

(21) Appl. No.: 18/748,527

(22) Filed: Jun. 20, 2024

Related U.S. Application Data
(63) Continuation of application No. PCT/EP2022/086624, filed on Dec. 19, 2022.

(30) Foreign Application Priority Data
Dec. 22, 2021 (EP) 21216802.5

(51) Int. Cl. H04W 52/02

(52) U.S. Cl. CPC H04W 52/0277

(57) ABSTRACT

A user device, UE, for a wireless communication system includes one or more antennas, a signal processor connected to the antenna, wherein the signal processor is to perform one or more operations, and a mains-independent power source connected to the signal processor to provide power to the signal processor for performing the one or more operations. The UE signals to one or more entities of the wireless communication system information indicating a status of the mains-independent power source, and/or that the UE is a device having a mains-independent power source, and/or the UE adapts one or more of operational procedures dependent on a status of the mains-independent power source.

### CROSS-REFERENCE TO RELATED APPLICATIONS

This application is a continuation of copending International Application No. PCT/EP2022/086624, filed Dec. 19, 2022, which is incorporated herein by reference in its entirety, and additionally claims priority from European Application No. 21216802.5, filed Dec. 22, 2021, which is also incorporated herein by reference in its entirety.

### TECHNICAL FIELD

The present invention relates to the field of wireless communication systems or networks, like a third generation partnership project, 3GPP, system or network, more specifically to the operation and/or control of user devices for such a network which include a mains-independent power source. Embodiments relate to a user device which includes a mains-independent power source and provides assistance information, like information indicating the user device to be mains-independent and/or a status of its mains-independent the power source. Further embodiments relate to a user device which includes a mains-independent power source and adapts one or more of its operation procedures dependent on a status of the mains-independent power source.

### BACKGROUND OF THE INVENTION

FIG. 1 (reflecting the collective of FIG. 1(a) and FIG. 1(b)) is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements of operation of user devices in a wireless communication system or network, having a mains-independent power source.

### SUMMARY

According to an embodiment, a user device, UE, for a wireless communication system may have: one or more antennas, a signal processor connected to the antenna, wherein the signal processor is to perform one or more operations, and a mains-independent power source connected to the signal processor to provide power to the signal processor for performing the one or more operations, wherein the UE is to
signal to one or more entities of the wireless communication system information indicating
   a status of the mains-independent power source, and/or
   that the UE is a device having a mains-independent power source, and/or
adapt one or more of operational procedures dependent on a status of the mains-independent power source.

Another embodiment may have a base station for a wireless communication system, wherein the base station is to serve one or more user devices, UEs, wherein the UE has a mains-independent power source for a signal processor of the UE to provide power to the signal processor for performing one or more operations, wherein the base station is to receive from the UE information indicating
a status of the mains-independent power source, and/or
that the UE is a device having a mains-independent power source, and
   wherein, responsive to the received information, the base station is to consider the information received for coordinating a communication of the UE and/or for controlling an operation of the UE.

According to another embodiment, a wireless communication system may have one or more user devices, UEs, according to the invention as mentioned above and/or one or more base stations according to the invention as mentioned above.

According to another embodiment, a method for operating a user device, UE, for a wireless communication system, the UE having one or more antennas, a signal processor connected to the antenna, wherein the signal processor is to perform one or more operations, and a mains-independent power source connected to the signal processor to provide power to the signal processor for performing the one or more operations, may have the steps of:
signaling, by the UE, to one or more entities of the wireless communication system information indicating
   a status of the mains-independent power source, and/or
   that the UE is a device having a mains-independent power source, and/or
adapting, by the UE, one or more of operational procedures dependent on a status of the mains-independent power source.

According to another embodiment, a method for operating a base station for a wireless communication system may have the steps of: serving one or more user devices, UEs, wherein the UE has a mains-independent power source for a signal processor of the UE to provide power to the signal processor for performing one or more operations, receiving from the UE information indicating
a status of the mains-independent power source, and/or
that the UE is a device having a mains-independent power source, and responsive to the received information, considering the information received for coordinating a communication of the UE and/or for controlling an operation of the UE.

Still another embodiment may have a non-transitory digital storage medium having stored thereon a computer program for performing the methods for operating a user device, UE, or a base station according to the invention as mentioned above when the computer program is run by a computer.

### BRIEF DESCRIPTION OF THE DRAWINGS

Embodiments of the present invention are now described in further detail with reference to the accompanying drawings, in which:

FIG. 1(a) is a schematic representation of an example of a radio access network RANₙ;

FIG. 1(b) is a schematic representation of an example of a radio access network RANₙ;

FIG. 2 is a schematic representation of a wireless communication system including a transmitter, like a base station, and one or more receivers, like user devices, UEs, implementing embodiments of the present invention;

FIG. 3 illustrates a user device, UE, in accordance with embodiments of the present invention, and a network entity in accordance with embodiments of the present invention;

FIG. 4 illustrates a DRX mode using an inactivity timer;

FIG. 5(a) illustrates a number of paging occasions, PO, existing during a certain period of time;

FIG. 5(b) illustrates the behavior of a UE at such paging occasions; and

FIG. 6 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

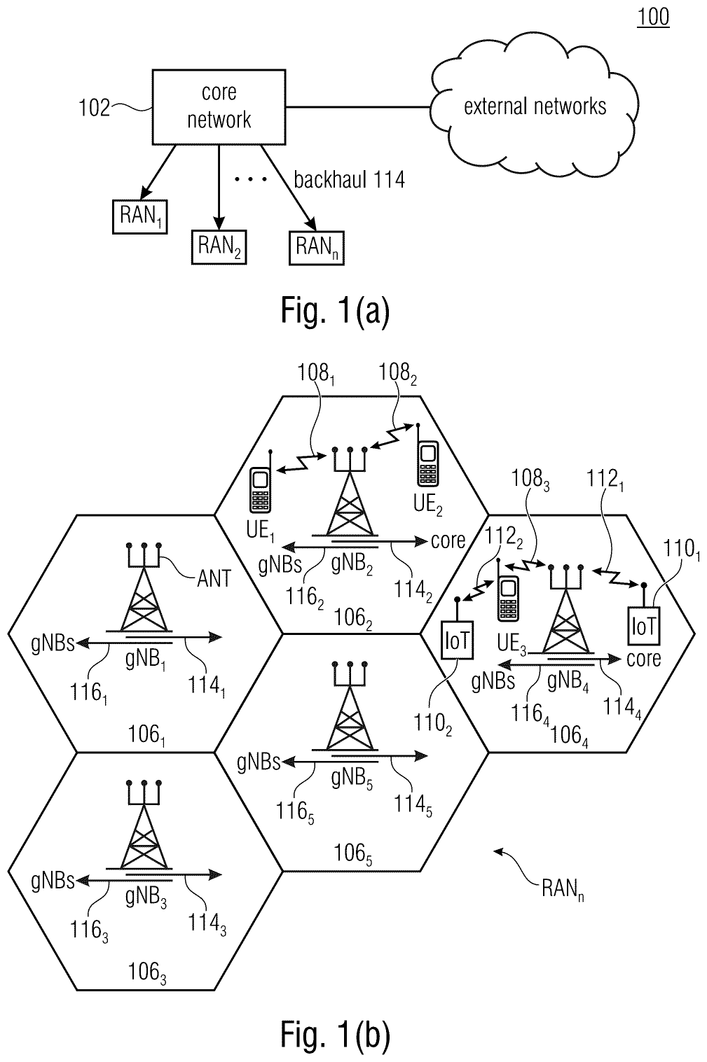

In a wireless communication network, like the one described above with reference to FIG. 1, user devices, UEs, may include a mains-independent power source including an energy storage device, like a battery or an accumulator or a capacitor, for providing the necessary power for operating the user device, for example its signal processor which is to carry out certain operations, like transmitting/receiving data over the user devices antenna or performing measurements. In other words, the UE does not have a permanent wired connection to an external power source, rather, it is supplied with power from its energy storage device that may be chargeable by connecting it to an external charging device or that may be charged by an energy harvesting device provided within the UE so that there is may be no need to connect the energy storage device to an external charging device for charging the energy storage device.

In the following description, reference is made to a battery-powered device and to an energy-harvesting device. The battery-powered device is a device, like a user device or UE, including a mains-independent power source having an energy storage that is charged by temporarily connecting the energy storage device, like the battery, to an external charging device. On the other hand, the energy-harvesting device is a device, like a user device or UE, including a mains-independent power source having an energy storage that is charged by an energy-harvester.

Both of the just-mentioned devices, the energy-harvesting device and the battery-powered device have quite stringent power constraints, and among the mentioned UEs, an energy-harvesting UE may have even more stringent power constraints than a battery-powered UE. The mentioned UEs may have charging times and active times which need to be taken into account for a proper communication, for example, over the 3GPP radio interface, like the Uu interface, or when performing certain operational procedures. In other words, the mentioned UEs may not be capable of being active all the time, rather, dependent on the type of energy storage device, there may be active times when a normal operation is possible and inactive times, when, for example, a power level or energy level provided by the energy storage device may not be sufficient for performing certain desired operations.

For example, the energy storage of a battery-powered UE may provide for a certain time power or energy that is at or above a level allowing at least basic operations of the UE. A certain operation may require a certain amount of power or energy over the entire operation time during so that, in case the energy level in the battery falls short of the required amount of energy during the operation time, the certain operation may not be completed. Thus, with regard to the certain operation the UE may not be active until the energy storage has been recharged by connecting the battery to an external charging device to at least the energy/power level required for the operation. In a similar way, dependent on the type of energy harvesting employed by an energy-harvesting UE, it may not be always possible to charge or maintain the energy storage at the required energy or power level allowing for carrying out the certain operation. Thus, with regard to the certain operation the UE may not be active until the energy storage has been recharged by the harvester to at least the energy/power level required for the operation.

The problem with battery-powered UEs and energy-harvesting UEs is that, in general, the wireless communication network is not aware that such UEs have mains-independent power sources. For example, when considering a sensor network including a plurality of sensors which communicate with the wireless communication network, like the 3GPP network, over the Uu interface or over the sidelink interface, some of the sensors may be permanently connected to a power source while others are battery-powered or obtain the energy from energy-harvesting devices. For example, a sensor associated with an electronic device or a machine may obtain its operating power from a power source of the electronic device or machine. For example, in case of vehicular UEs, the UE may be connected to a power source of the vehicle, like its battery, and, therefore, it is considered a UE that is permanently connected to a power source. On the other hand, a user device being associated with a temperature sensor which, in turn, is mounted at a certain location for sensing a temperature of, e.g., a heating device, is not connected to any other power source so that in this case, a battery-powered UE or an energy-harvesting UE is employed.

As mentioned above, dependent on how the UEs are provided with electrical power, the active/inactive times may vary significantly. For example, a UE being permanently connected to an independent power source may be operated constantly, while battery-powered UEs or energy-harvesting UEs may only be operated during their active time i.e., when sufficient energy or power is provided by the energy storage device for a certain operation to be carried out. The problem is that the wireless communication network has no knowledge about whether a UE has a mains-independent power source or has a power source connected to an external power device permanently so that the wireless communication network may not react to certain situations in case battery-powered UEs or energy-harvesting UEs are not able to provide sufficient energy for a certain operation without being recharged. In other words, conventional wireless communication networks are not able to cope with the constraints encountered in battery-powered UEs and energy-harvesting UEs, like the constraint that such devices may not be capable of being active for a certain time due to limitations in the available energy or power to perform a desired operation, like performing a certain transmission or reception of data.

Thus, there is a need for providing improvements or enhancements when operating user devices in a wireless communication network which include a mains-independent power source.

The present invention addresses the above-described problems by providing an approach in accordance with which a UE having a mains-independent power source, like the above-mentioned battery-powered UE or the above-mentioned energy-harvesting UE, provides information to the wireless communication network, for example assistance information, which indicates the UE to be mains-independent and/or a status of the mains-independent power source. Also, the UE may adapt one or more operation procedures dependent on the status of the mains-independent power source.

Also, an approach is provided in accordance with which a network entity, like a base station or another UE with which the battery-powered UE or the energy-harvesting UE communicates over a sidelink, receives the above-mentioned information, namely that the UE is mains-independent or the status of the mains-independent power source, and uses this information for controlling the communication of the UE with other devices in the network and/or for controlling one or more some operation procedures of the UE.

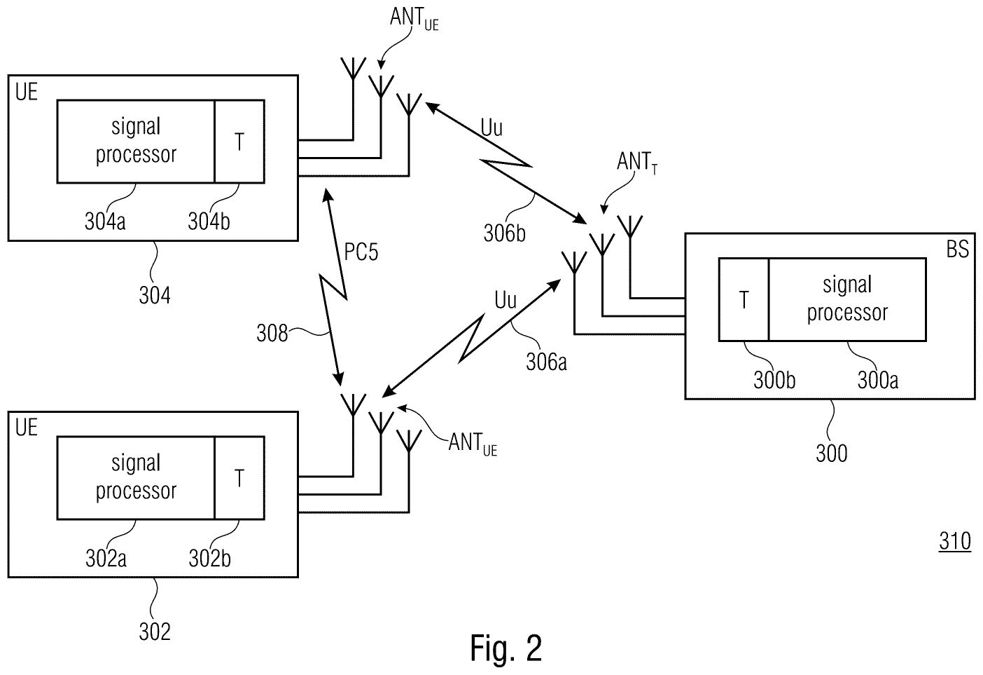

Embodiments of the present invention may be implemented in a wireless communication system as depicted in FIG. 1 including base stations and users, like mobile terminals or IoT devices or industrial IoT (IIoT) devices. FIG. 2 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 2, the one or more UEs 302, 304 of FIG. 2, and the base station 300 of FIG. 2 may operate in accordance with the inventive teachings described herein.

### Assistance Information/Adjustment of Operation

### UE

The present invention provides a user device, UE, for a wireless communication system, comprising:
one or more antennas,
a signal processor connected to the antenna, wherein the signal processor is to perform one or more operations, and
a mains-independent power source connected to the signal processor to provide power to the signal processor for performing the one or more operations,
wherein the UE is to
   signal to one or more entities of the wireless communication system information indicating
      a status of the mains-independent power source, and/or
      that the UE is a device having a mains-independent power source, and/or
   adapt one or more of operational procedures dependent on a status of the mains-independent power source.

In accordance with embodiments, the UE is to signal the information
at configured or preconfigured times, e.g. when connecting or re-connecting to the wireless communication system, and/or
with a configured or preconfigured periodicity, and/or
in response to one or more configured or preconfigured criteria, and/or
in response to a request from one or more entities of the wireless communication system, like a base station or another UE.

In accordance with embodiments, the information indicating the status of the mains-independent power source comprises one or more of the following:
a power or energy level the mains-independent power source is able to provide for powering the signal processor to perform the one or more operations,
that the mains-independent power source is not able to provide a first power or energy level required for powering the signal processor to perform the one or more operations,
that the mains-independent power source is not able to provide a first power or energy level required for powering the signal processor to perform the one or more operations but only a second power or energy level that is lower than the first power or energy level,
that the mains-independent power source is able to provide the first power or energy level required for powering the signal processor to perform the one or more operations only for a certain time period,
that a power or energy level the mains-independent power source is able to provide is at or below a configured or preconfigured threshold and that the UE enters a configured or preconfigured low power mode,
a health status of the mains-independent power source,
an estimated remaining mains-independent power source time indicating how long the UE is expected to be able to perform the one or more operations, e.g., to stay active,
a critical power state causing the UE to enter a pre-configured low power mode

In accordance with embodiments, the health status of the mains-independent power source comprises one or more of the following:
an age of the mains-independent power source, like a manufacturing date,
a ratio of the maximum power that the mains-independent power source is still capable to deliver, e.g., due to corruption or aging effects,
a full charge capacity of the mains-independent power source, indicated, e.g., by a percentage of a known maximum charge capacity,
a number of charging cycles performed by the mains-independent power source,
a number of charging cycles left for the mains-independent power source, e.g., a charging countdown,
a usage of the mains-independent power source, e.g., an average current, power or voltage, a maximum current, power or voltage, a minimum current, power or voltage,
an indication that the UE is no longer able to perform at a predefined performance, like a peak performance, e.g., due to a current charge of the mains-independent power source, a current temperature of the mains-independent power source an age of the mains-independent power source.

In accordance with embodiments, the mains-independent power source comprises an energy storage device.

In accordance with embodiments, the energy storage device, e.g., a battery or an accumulator, is chargeable by connecting the energy storage device to an external charging device.

In accordance with embodiments, the information indicating the status of the mains-independent power source comprises one or more of the following:
a recovery of the energy storage device,
a time for which the UE is able to perform the one or more operations, like an active time of the UE.

In accordance with embodiments, the UE is an energy harvesting UE and comprises an energy harvesting device for charging the energy storage device, e.g., a battery or an accumulator or a capacitor, without the need to connect the energy storage device to an external charging device.

In accordance with embodiments, the energy harvesting device comprises one of more of the following:
a device for harvesting energy from motion, like a mechanical energy converter such as a piezoelectric generator or a dynamo or an alternator or a generator or a small windmill,
a device for harvesting energy from radiation, like a solar module,
a device for harvesting energy from chemical reactions, like a small hydrogen fuel cell,
a device for harvesting energy from a radio signal, like the radio signal from the base station or another UE in the proximity
a device for harvesting energy from temperature differences, like a Peltier element.

In accordance with embodiments, the information indicating the status of the mains-independent power source comprises one or more of the following:
a recovery of the energy storage device,
a time for which the UE is able to perform the one or more operations, like an active time of the UE or an inactive time of the UE.

In accordance with embodiments, the recovery comprises one or more of the following:
a recovery rate of the energy storage device which indicates how fast the energy harvesting device is able to recharge or recover the energy storage device to provide a power or energy level allowing the UE to perform the one or more operations,
a recovery time or rate of the energy storage device, e.g., active Rx seconds or Tx seconds recovered per hour or the ratio between active Rx seconds and Tx seconds, which indicates a time the energy storage device requires to
   recover from a last operation to provide a power or energy level allowing the UE to perform the one or more operations, or
   reach a configured or preconfigured power or energy level.

In accordance with embodiments, the UE is to estimate the recovery of the energy storage device using one or more of the following:
a current harvesting current or power provided by the energy harvesting device,
a minimum harvesting current or power provided by the energy harvesting device,
an average energy harvesting current or power provided by the energy harvesting device over a certain configured or preconfigured time window.

In accordance with embodiments, the UE is to report one or more operating parameters of the energy harvesting device to a network entity, like a base station or another UE, for allowing the network entity to estimate the recovery of the energy storage device, the operating parameters including one or more of the following:
a current harvesting current or power provided by the energy harvesting device,
a minimum harvesting current or power provided by the energy harvesting device,
an average energy harvesting current or power provided by the energy harvesting device over a certain configured or preconfigured time window.

In accordance with embodiments, the time for which the UE is able to perform the one or more operations indicates one or more of the following:
a percentage of a certain time duration, like a transmit time or a receive time, for which the energy storage device, like a capacitor, is able to provide a certain power or energy level that allows the UE to perform the one or more operations, like sending bursts of data and receiving data,
a ratio between an operational time of the UE during which the UE performs the one or more operations, and a recovering time of the UE during which the energy storage device is charged to a power or energy level allowing the UE to perform the one or more operations,
a percentage of a certain time duration, like a transmit time or a receive time, for which the energy harvesting device is able sustain a certain power or energy level in the energy storage device that allows the UE to perform the one or more operations.
a ratio between an operational time during which the energy harvesting device is able sustain a certain power or energy level in the energy storage device that allows the UE to perform the one or more operations, and a recovering time during which the energy harvesting device charges the energy storage device to a power or energy level allowing the UE to perform the one or more operations.

In accordance with embodiments, the UE is to signal to the one or more entities of the wireless communication system a UE power or energy consumption level, like an average power consumption over a certain configured or preconfigured time window, or for a certain configured or preconfigured operation, e.g., a transmission burst.

In accordance with embodiments, the one or more operations comprise one or more of the following:
transmitting to the one or more entities of the wireless communication system,
receiving from the one or more entities of the wireless communication system,
performing measurements of an environment of the UE,
sending bursts of data and receiving data,
sensing, e.g., a physical sidelink control channel, PSCCH,
processing feedback channels, e.g., a physical sidelink feedback channel, PSFCH,
one or more paging operations,
decoding one or more control channels, like Physical Downlink Control Channels, PDCCHs, or Physical Sidelink Control Channels, PSCCHs.

### Adjustment of DRX/Paging/Control Channel Monitoring/Measurement Procedure

### UE

In accordance with embodiments, the UE is to adapt one or more of the following procedures dependent on a status of the mains-independent power source:
a Discontinuous Reception, DRX, procedure,
a paging procedure,
a control channel monitoring procedure, like a Physical Downlink Control Channel, PDCCH, or a Physical Sidelink Control Channel, PSCCH,
a measurement procedure.

### Adjustment of DRX/Paging Procedure

In accordance with embodiments,
the UE is to start or to perform the one or more operations when a power or energy level provided by the energy storage device is at or above a configured or preconfigured threshold, and
dependent on a recovery time required, after completing the one or more operations, for charging the energy storage device, e.g., by an energy harvesting device, to a power or energy level at or above the configured or preconfigured threshold, the UE is to adapt one or more of the following procedures:
   a Discontinuous Reception, DRX, procedure,
   a paging procedure.

In accordance with embodiments, the UE is to skip one or more DRX occasions and/or paging occasions which, after completing the one or more operations, occur during the recovery time.

In accordance with embodiments, the UE is to report the skipping of a DRX occasion and/or a paging occasion to one or more entities of the wireless communication system, like a base station or a core network entity, e.g., by using a Random Access CHannel, RACH, or by collecting skipped DRX occasions and/or paging occasions and reporting once the energy storage device is charged to a power or energy level at or above the configured or preconfigured threshold.

In accordance with embodiments, reporting the skipping of DRX occasions and/or a paging occasions includes one or more of the following:
a number of skipped DRX occasions or paging occasions,
a time since a first or a last skipped DRX occasion or paging occasion,
a bitmap of DRX occasions where the skipped or monitored DRX occasions are indicated, e.g., a bitmap represented as a dense vector, or a bitmap represented as a sparse vector.

In accordance with embodiments, in case a charging state or a health status of the energy storage device is at or below the configured or preconfigured threshold, the UE is to perform one or more of the following actions:
shorten a DRX ON duration and/or inactivity timer,
increase a DRX OFF duration,
transmit the charging state of the energy storage device to one or more entities of the wireless communication system, like a base station or a core network entity.

In accordance with embodiments, in case a health status of the energy storage device is at or below the configured or preconfigured threshold, the UE is to change from a mobile initiated communication, MICO, mode to a network initiated communication, NICO, mode.

In accordance with embodiments, the UE is to prolong the DRX ON duration by triggering a DRX inactivity timer only if a certain condition of the energy storage device is fulfilled, e.g., a power or energy level is above a configured or preconfigured threshold.

In accordance with embodiments, in case the condition is not fulfilled, the UE is to signal to one or more entities of the wireless communication system that the DRX ON duration is not prolonged or that the DRX inactivity timer is not triggered.

In accordance with embodiments, the UE is to
determine the recovery time, or
receive the recovery time from one or more entities of the wireless communication system, like a base station or a core network entity.

### Adjustment of Control Channel Monitoring Procedure

In accordance with embodiments, the UE has a certain minimum control channel monitoring capability, like a minimum and/or maximum PDCCH or PSCCH monitoring capability, the certain minimum and/or maximum control channel monitoring capability depending on the status of the mains-independent power source.

In accordance with embodiments, the UE is to report the status of the mains-independent power source to one or more entities of the wireless communication system, like a base station, and receive the minimum and/or maximum control channel monitoring capability from the entity of the wireless communication system.

In accordance with embodiments, the UE is determine the minimum control channel monitoring capability using the status of the mains-independent power source, and report the determined minimum control channel monitoring capability to one or more entities of the wireless communication system, like a base station.

In accordance with embodiments, the minimum control channel monitoring capability comprises one or more of the following:
a control channel monitoring periodicity that increases/decreases with an increase/decrease of the length of the DRX ON duration,
a control channel monitoring periodicity that increases/decreases with an increase/decrease of the duration of the DRX inactivity timer,
a number of control channel monitoring occasions that increases/decreases with an increase/decrease of a recovery rate or a recovery time of the energy storage device,
a number of control channel monitoring occasions and/or a number of schedulings per DRX ON duration that depends on a charging state or a health status of the energy storage device, like a battery level, wherein charging state or a health status of the energy storage device at or below the configured or preconfigured threshold, causes the UE to change from a mobile initiated communication, MICO, mode to a network initiated communication, NICO, mode.

In accordance with embodiments,
the UE is to monitor a plurality of search spaces for control channel monitoring occasions, and
the UE is to deactivate monitoring one or more of the plurality of search spaces for control channel monitoring occasions, if a charging state, like a power of energy level, of the energy storage device drops under a certain configured or preconfigured threshold.

In accordance with embodiments, the UE is to deactivate monitoring the search spaces in accordance with a configured or preconfigured deactivation order.

In accordance with embodiments, the UE is to choose a deactivation order from a plurality of configured or preconfigured deactivation orders under consideration of a power or energy consumption level.

In accordance with embodiments, the UE is to inform one or more entities of the wireless communication system, like a base station, that the UE is to recover energy, and receive from the entity of the wireless communication system a control channel skipping configuration or one or more new search spaces to monitor for control channel monitoring occasions, thereby giving the UE time to recharge.

### Adjustment of Measurement Procedure

In accordance with embodiments, if the charging state of the energy storage device drops under a certain configured or preconfigured threshold, the UE is to
deactivate one or more configured or preconfigured measurements, like a secondary cell, SCell, measurement, and/or
deactivate or reduce a frequency of measurement reporting to one or more entities of the wireless communication system, like a base station, e.g., a channel state information, CSI, reporting.

In accordance with embodiments, the UE is to deactivate the one or more measurements and/or reports in accordance with a configured or preconfigured deactivation order,

In accordance with embodiments, the UE is to choose a deactivation order from a plurality of configured or preconfigured deactivation orders.

In accordance with embodiments, the UE is to send a report to the one or more entities of the wireless communication system, like a base station, which specifies which measurements the UE is able to perform further and/or which measurements the UE is not able to perform further at a current condition of the energy storage device, like a current power or energy level or a current recovery rate or time.

In accordance with embodiments, responsive to the report, the UE is to receive from the entity of the wireless communication system one or more of the following:
a list of measurements and/or reports to be activated and/or deactivated,
a list of relaxation measures, like a reduced frequency of measurements and/or reports, or a relaxation of one or more processing times for the signal processor, e.g. due to a clock reduction;
for one or some or all types of measurements an individual new measurement configuration.

In accordance with embodiments, the report includes a bit map and refers to measurement features such as one or more of the following:
Radio Link Monitoring, RLM, measurements,
Beam Failure Detection, BFD, measurements,
intra-frequency Radio Resource Management, RRM, measurements,
inter-frequency RRM measurements,
CSI reporting, and
   wherein the report, optionally, also contains an indication if the UE considers itself stationary, e.g., based on one or more internal sensors or based on a positioning procedure.

### gNB

The present invention provides a base station for a wireless communication system,
wherein the base station is to serve one or more user devices, UEs, wherein the UE comprises a mains-independent power source for a signal processor of the UE to provide power to the signal processor for performing one or more operations,
wherein the base station is to receive from the UE information indicating
   a status of the mains-independent power source, and/or
   that the UE is a device having a mains-independent power source, and
wherein, responsive to the received information, the base station is to consider the information received for coordinating a communication of the UE and/or for controlling an operation of the UE.

In accordance with embodiments, responsive to the received information, the base station is to adapt one or more of the following:
a scheduling, e.g., how frequently a wake-up signal or a paging is transmitted to the UE,
conveying of control information based on which search spaces, e.g., control resource sets, CORESETs, are expected to be monitored by the UE,
configuring the operations accordingly, e.g. configure the UE with less blind decoding attempts to make the UE last longer,
configuring configured grants,
configuring or scheduling sidelink resources, e.g., resource pools,
sensing modes,
grants

In accordance with embodiments, responsive to the received information, the base station is to adapt one or more of the following operational procedures performed by the UE:
a Discontinuous Reception, DRX, procedure,
a paging procedure,
a control channel monitoring procedure, like a Physical Downlink Control Channel, PDCCH, or a Physical Sidelink Control Channel, PSCCH,
a measurement procedure.

In accordance with embodiments, the base station is to perform one or more of the following:
receive from the UE a report of the one or more criteria, determine a minimum control channel monitoring capability, and signal the determined minimum control channel monitoring capability to the UE,
receive from the UE a signaling indicating that the UE is to recover energy, determine a control channel skipping configuration or one or more new search spaces to be monitored for control channel monitoring occasions, and signal the control channel skipping configuration or the new search space to the UE, thereby giving the UE time to recharge,
receive from the UE a report which specifies which measurements the UE is able to perform further and/or which measurements the UE is not able to perform further at a current condition of the energy storage device, and determine and forward to the UE one or more of the following:
   a list of measurements and/or reports to be activated and/or deactivated,
   a list of relaxation measures, like a reduced frequency of measurements and/or reports,
   for one or some or all types of measurements an individual new measurement configuration.

In accordance with embodiments, the base station is to serve one or more energy harvesting user devices, UEs, wherein the energy harvesting UE comprises an energy storage device for a signal processor of the UE to provide power to the signal processor for performing one or more operations, and an energy harvesting device for charging the energy storage device without the need to connect the energy storage device to an external charging device.

In accordance with embodiments, the UE comprise a user device, UE, according to the present invention.

### System

The present invention provides a wireless communication system, comprising a one or more user devices, UEs, according to the present invention and/or one or more base stations according to the present invention.

In accordance with embodiments, the UE comprise one or more of the following: a power-limited UE, or an energy-harvesting UE or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments, the base station comprises one or more of the following: a macro cell base station, or a small cell base station, or a central unit of a base station, or a distributed unit of a base station, or an Integrated Access and Backhaul, IAB, node, or a road side unit, RSU, or a UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Methods

The present invention provides a method for operating a user device, UE, for a wireless communication system, the UE comprising one or more antennas, a signal processor connected to the antenna, wherein the signal processor is to perform one or more operations, and a mains-independent power source connected to the signal processor to provide power to the signal processor for performing the one or more operations, the method comprising:
signaling, by the UE, to one or more entities of the wireless communication system information indicating
   a status of the mains-independent power source, and/or
   that the UE is a device having a mains-independent power source, and/or
adapting, by the UE, one or more of operational procedures dependent on a status of the mains-independent power source.

The present invention provides a method for operating a base station for a wireless communication system,
serving one or more user devices, UEs, wherein the UE comprises a mains-independent power source for a signal processor of the UE to provide power to the signal processor for performing one or more operations,
receiving from the UE information indicating
   a status of the mains-independent power source, and/or
   that the UE is a device having a mains-independent power source, and
responsive to the received information, considering the information received for coordinating a communication of the UE and/or for controlling an operation of the UE.

### Computer Program Product

Embodiments of the first aspect of the present invention provide a computer program product comprising instructions which, when the program is executed by a computer, causes the computer to carry out one or more methods in accordance with the present invention.

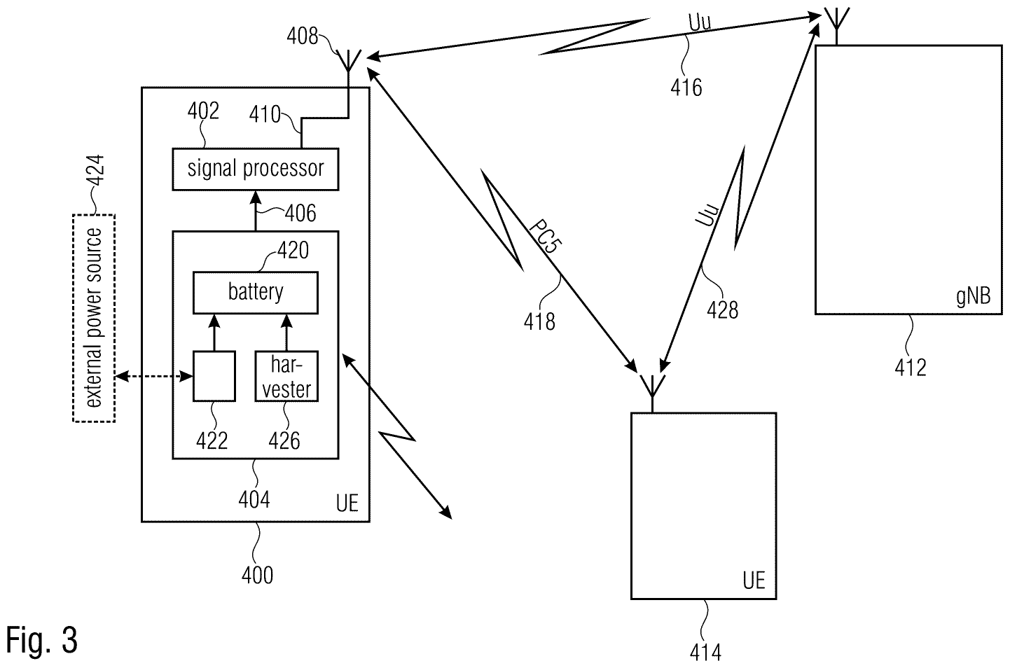

FIG. 3 illustrates a user device, UE, in accordance with embodiments of the present invention. UE 400 including a signal processor 402, a mains-independent power source 404 connected, as indicated at 406, to the signal processor 402 which, in turn, is connected to an antenna 408 of the UE 400, as is indicated at 410. UE 400 is to communicate with a base station or gNB 412 and/or a further UE 414. UE 400 communicates with the gNB 412 over the Uu interface 416, and with the UE 414 over the PC5 or sidelink interface 418. Moreover, UE 400 may perform measurements of its environment, e.g., measurements on resources used for the communication with the gNB 412 and with the UE 414 as provided by the wireless communication system or network.

In accordance with embodiments, the signal processor 402 of UE 400 may perform certain operations, for example one or more operations including the transmission and reception of data over the interfaces 416 and/or 418 as well as measurements on the resources used for the communication. The signal processor 402 may perform digital signal processing and/or analog signal processing and may include auxiliary support circuits, for example voltage rectifiers and power amplifiers as well as sensors and/or actuators and other analog circuitries. To be able to perform the one or more operations, the signal processor 402 draws from the mains-independent power source 404 a power level or energy level as required to perform the one or more operations, e.g., in accordance with a predefined performance requirement.

In accordance with embodiments, the mains-independent power source 404 includes an energy storage device, like a battery 420, for storing energy to be provided to/drawn by the signal processor 402.

In accordance with embodiments, UE 400 may include a terminal 422 by which the UE 400 may be connected temporarily to an external power source 424 to allow charging the battery 420 once its power/energy level drops below a certain threshold. In accordance with the first embodiments, UE 400 is also referred to as a battery-powered UE.

In accordance with further embodiments, instead of having a battery that is recharged by temporarily connecting it to the external power source 424, the UE 400 may include an energy-harvesting device or harvester 426 for charging the battery 420 so that there is no need to connect the battery 420 to an external power source 424. In accordance with embodiments, the harvester 426 may harvest energy from motion, like a mechanical energy converter such as a piezoelectric generator or a dynamo or an alternator or a generator or a small windmill. In accordance with other embodiments, the harvester may harvest energy from radiation, like a solar module. In accordance with yet other embodiments, the harvester may harvest energy from chemical reactions, like a small hydrogen fuel cell. In accordance with further embodiments, the harvester may harvest energy from a radio signal, like the radio signal from the base station or another UE in the proximity, e.g., by magnetic induction. In accordance with yet further embodiments, the harvester may harvest energy from a temperature difference, like a Peltier element. A UE 400 including a harvester 426 is referred to in the following also as an energy-harvesting UE.

In accordance with yet further embodiments, UE 400 may include both the terminal 422 and the harvester 426 so that battery 420 may be charged both by energy obtained by the harvester 426 and by energy received from the external power source 424.

In accordance with other embodiments, no energy storage device may be provided in the mains-independent power source 404, and the UE 400 may be a device which only wakes up when enough power is generated, e.g., in case the harvester 426 generates sufficient energy.

In either of the above embodiments, due to the nature of the mains-independent power source 404, only a temporary operation of the UE 400 is possible or, stated differently, a continuous or uninterrupted operation of the UE is not possible.

To address the problems encountered in conventional wireless communication networks, namely that the network entities to which the UE 400 may be connected are not aware about potential energy constraints due to an energy/power level the battery 420 is able to provide to the signal processor, in accordance with the present invention, UE 400 signals to the wireless communication network, for example to the gNB 412 or to the sidelink UE 414 that UE 400 is a device having the mains-independent power source 404, thereby informing the other network entities about the situation and allowing them to cope with the potential constraints experienced when the power level/energy level of the battery 420 may be assumed to be below a certain threshold for performing a certain operation by the UE 400.

In accordance with further embodiments, UE 400 may signal to the other network entities information representing the status of the mains-independent power source 404, for example the status of the battery 420, or certain information about the functionality of the harvester 426, or information indicating whether UE 400 is connected to the external power source or not.

In accordance with yet further embodiments, UE 400, dependent on the status of the mains-independent power source 404 may also control one or more operational procedures to be performed by the signal processor so as to adapt any processing by or operation of the UE to the status of the power source 404, for example to a power/energy level that may be provided by the battery 420, or the amount of power/energy that may be provided to charge or sustain the battery by means of the harvester 426 or when connecting it to the external power source 424.

Thus, UE 400 may perform one or more of the following operations:
signal to the one or more entities of the wireless communication system the information indicating the status of the mains-independent power source 404,
signal to the one or more entities of the wireless communication system information indicating that the UE is a device having a mains-independent power source 404,
adapt one or more operational procedures dependent on the status of the mains-independent power source 404.

### Signalinq Information Reqardinq UE's Mains-Independent Power Source

In accordance with embodiments, UE 400 may signal the above-described information, namely whether it is a device having a mains-independent power source and/or the status of the mains-independent power source at certain times, for example at configured or preconfigured times like when connecting or re-connecting to the wireless communication network or system. For example, when connecting or reconnecting to the network in accordance to the random access channel, RACH, procedure, the information may be included in the message Msg1 or in the message Msg3 of the RACH procedure in case of a four-step RACH procedure, or in the message MsgA in case of a two-step RACH procedure. In accordance with other embodiments, the information may be provided by the UE over the Uu interface 416 and the PC5 interface 418 with a configured or preconfigured periodicity. In accordance with other embodiments, the information may be provided by UE 400 to the respective network entities 412, 414 in response to one or more configured or preconfigured criteria. The criteria may include, e.g., one or more of the following:
the current status or the status within a time window of the energy harvester, e.g., the signaling may be performed only if harvester cannot harvest a sufficient amount of energy,
a battery status, e.g., the signaling may be performed only if the battery reaches a low status,
in response to a request received, for example, from the gNB 412 or from the UE 414.

In accordance with embodiments, the information indicating the status of the mains-independent power source 404 may include one or more of the following:
A power or energy level is indicated which the mains-independent power source 404 is able to provide for powering the signal processor 402 to perform one or more operations. For example, UE 400 may be capable of performing different operations, like transmitting and/or receiving data over the interfaces 416, 418 or performing measurements on the environment of UE 400, and dependent on specifics of the operation, the signal processor 402 may require different power levels or energy levels, so that signaling to the network a power level that the UE 400 is able to provide avoids situations in which the network, for example the gNB 412 or the sidelink UE 414, request the UE 400 to perform a certain operation, like a measurement or a data transmission from which, currently, the battery 420 is not capable to provide sufficient power or energy. In other words, dependent on the information about the power level the mains-independent power source is able to provide, the network entities 412, 414 may decide whether certain operations are to be initiated with regard to the UE 400.
Rather than providing the actual power or energy level, UE 400 may provide an indication of a certain power energy level that its power source 404 may not provide so that certain operations may not be performed. Thus, the network entities receive a certain power level and on the basis of this power level and the knowledge about the required power level for performing a certain operation, for example the gNB, may decide to initiate or not initiate a certain operation with the UE 400.
UE 400 may signal to the network entities a further, lower power level that may be provided for operating the signal processor 402 thereby allowing the network entities to select operations for the UE 400 that may be performed given the lower power level available at the UE 400.
UE 400 may indicate to the network entities that it is capable to provide a certain power or energy level for a certain operation by means of the power source 404 only for a certain period of time. In other words, UE 400 determines a time period during which the power or energy available from battery 420 for performing an operation by signal processor 402 is estimated to be at or above a certain threshold required for performing an operation, and this information allows the other network entities 412, 414 to organize a timing of certain operations in such a way that they are only requested during a time period during which it is ensured that UE 400 has actually sufficient energy or power for performing the operation.
Information that UE 400 enters a configured or preconfigured low power mode, for example in a situation when the power source 404 is not able to provide a power level at or above a configured or preconfigured threshold. In other words, once the power level provided by the power source 404 drops below a configured or preconfigured threshold or reaches such a threshold, the UE 400 signals to the other network entities that it is now in a low power mode so that any of the network entity may control operations in the UE 400, like a communication with a UE or a measurement to be performed by the UE, in such a way that the currently limited power capabilities are taken into account. For example, more power intensive operations, like transmitting certain reports which are not immediately needed, may be deferred to a later point or may even be omitted at this time.
An estimated remaining mains-independent power source time which indicates how long UE 400 is expected to perform the one or more operations, for example to stay in an active mode or provide the power/energy needed for an operation. Again, on the basis of this information, the network entities may schedule certain operations to be carried out with regard to UE 400 in such a way that they are performed at times the UE 400 has sufficient energy for performing such operations.
The power source 404 enters a critical state, for example in case the battery 420 is deeply discharged or the battery has a reduced capacity, e.g., due to its age or due to a large number of charging cycles performed, and charging is not likely to occur because the harvester 426, for example, is not able to provide energy or because it is not possible to connect the battery to the external source 424. This may be signaled to the other network entities, together with the indication that the UE 400 enters the above-mentioned low power mode.

In accordance with embodiments, the above-mentioned times or time periods during which the UE 400 is able to provide a certain power level or energy level may be indicated or reported to the network in terms of achievable transmit, Tx, time and/or receive, Rx, time. In other words, it may be indicated that the UE is active or inactive for transmitting or receiving over the interface or for performing respective measurements.

Furthermore, the UE 400 may provide information on a future point in time when it is able to transmit or receive, e.g., the point in time that it has enough energy harvested as to perform this action. In addition, The UE 400 may also inform the network or another UE about a possible duration of a transmission and/or reception as well as provide further parameters on either of its transmission and/or reception configuration. E.g., it may provide information on the possible frequency bandwidth it supports for a transmission and/or reception.

In accordance with further embodiments, also a maximum achievable transmit power may be indicated to the network entities. This enables to adjust the transmit power and other parameters, such as the Modulation and Coding Scheme, MCS, accordingly. For example, the network may consider that the UE is only capable to reach a certain transmit power level and lower the code rate instead of increasing the transmit power in the UL grant, so that the transmission from the UE may be received successfully. Furthermore, the network may optimize the power spectral density of the transmission or reception by reconfiguring the UE to use a lower/higher channel bandwidth, e.g., 5 MHz channel bandwidth, so that the UE uses its transmit power or receiver amplification as efficient as possible.

In accordance with embodiments, the health status of the mains-independent power source 404 may be signaled by UE 400 to the gNB 412 and/or to the UE 414 over the respective interfaces 416, 418. For example, an age of the mains-independent power source 404, or an age of the battery 420 may be signaled, for example, on the basis of a known manufacturing date of the respective device. The network entities receiving this information may judge that the power source 404 has reached a certain age so that it is more or increasingly likely than an original full charge capacity is no longer reachable. For example, based on empirical data, the network entities may consider a power source 404 of a certain age to have a certain percentage of an original maximum charge capacity, so that, based on the knowledge about the maximum possible power level/energy level available at the UE 400, respective operations with the UE 400 may be controlled, for example, certain operations exceeding the power level that may be provided by UE 400 may be omitted or replaced by similar operations with less power requirements. For example, the network may increase the measurement intervals or PDCCH monitoring intervals. In another example, the network may prefer a lower code rate (MCS) or smaller bandwidth instead of increasing the transmit power when the reception quality drops. Furthermore, the network may also shorten a DRX ON duration.

In accordance with further embodiments, UE 400 may indicate a ratio of the maximum power that the mains-independent power source is still capable to deliver, e.g., due to corruption or aging effects.

In accordance with other embodiments, instead of judging the potential full charge capacity, UE 400 may explicitly indicate a current or actual full charge capacity of the power source 404, for example, by indicating a percentage of a known maximum charge capacity to which UE 400 is capable to charge battery 420. In accordance with yet other embodiments, the health status may be signaled as a number of charging cycles already performed or as a number of charging cycles left for the power source, like a charging countdown, and on the basis of the number of charging processes already performed or the number of charging processes remaining, the respective network entities may judge an age and an associated actual maximum of full capacity achievable by the battery. On the basis thereof, the operations to be performed with regard to UE 400 may be controlled. In accordance with further embodiments, the usage of the power source 404 may be signaled, for example, by indicating an average current, power or voltage, a maximum current, power or voltage, or a minimum current, power or voltage, on the basis of which the network entities may judge to what extent the battery 420 of the UE 400 may be charged, i.e., what the actual full charge capacity or the achievable full charge capacity may be.

In accordance with yet further embodiments, UE 400 may indicate to the network entities that it is no longer able to perform in accordance with predefined performance parameters, like a peak performance for a certain operation because an actual charge of the power source, an actual temperature thereof or an age thereof is beyond a certain threshold. In other words, in case the UE 400 detects a power source 404 not being able to sustain a required power/energy for a normal operation, it may indicate this to the network. This power mode may avoid voltage drops and a malfunction of the UE. For example, the UE may lower its clock and perform operations slower. Hence, the network may assume accordingly longer processing times for, e.g., PDCCH and/or PDSCH and/or PUSCH and/or PUCCH and/or CSI. This may also referred to as a relaxed UE processing timeline or as a relaxation of one or more processing times for the signal processor, e.g. due to the clock reduction, which may cause the signal processor to perform at least certain operations slower. In particular for the downlink, the maximum number of blind decodes per slot may be reduced, a longer time between the PDCCHs may be assumed. For the uplink, a longer PUSCH preparation time may be assumed by the network. Hence, causing the network to provide the DCI scheduling a PUSCH accordingly earlier. Furthermore, the network may prefer lower transmit power in order to avoid a voltage drop at the UE. Furthermore, the above-mentioned power saving techniques may be combined with a bandwidth reduction that may be applied in certain frequency bands, e.g., the UE may be configured to use a 5 MHz bandwidth in FR1. Another power saving technique that may be used is to reduce the UEs peak data rate, which may also be in combination with usage in a certain frequency band, e.g., in FR1. This may also be configured with a restricted bandwidth for PDSCH and/or PUSCH or with a restricted processing timeline as mentioned above.

In accordance with further embodiments, the information about the status of the mains-independent power source 404 as provided to the network entities 412 and/or 414 may indicate a recovery of the battery 420 or energy storage device, and/or a time for which the UE 400 is able to perform the one or more operations, which may be indicated as an active time of the UE in terms of transmit time and/or receive time, as mentioned above. In accordance with embodiments, the information about the recovery may include a recovery rate of the battery 420 indicating how fast the harvester 426 or external charger 424 is able to recharge or recover the battery to provide a power level or energy level, which allows UE 402 to perform a certain operation. In accordance with other embodiments, the recovery information may indicate a recovery time or rate of the battery 420, for example, in terms of active Rx seconds or Tx seconds recovered per hour or in terms of the ratio between active Rx seconds and Tx seconds. The recovery time or rate indicates a time the energy storage device, like the battery 420, requires to recover from a latest operation in such a way that it may provide again power or energy at a level allowing the UE to perform further operations. In accordance with other examples, the recovery time or rate may indicate the duration it takes the battery to reach a configured or preconfigured power or energy level.

UE 400 may estimate the recovery of the battery 420 based on one or more of the following information concerning the harvester 426:
an actual harvesting current or power,
a harvesting current or power provided over a certain configured or preconfigured time window.

Based on the recovery information, the respective network entities are aware of a current or actual status of the battery 420 and a time period until when a certain level is achieved so that the network entities may control UE 400 to perform certain operations at appropriate times when sufficient energy may be provided by the battery 420.

In accordance with other embodiments, rather than estimating the recovery at the UE 400, UE 400 may actually send the operation parameters of the harvester 426, like the above-mentioned actual harvesting current or power, the minimum harvesting current or power, the average harvesting current or power to the gNB 412 or to the SL-UE 414 which, on the basis of the received information may determine the recovery time or recovery rate of the battery 420 of UE 400. Furthermore, the UE may derive the recovery time or recovery rate of the battery itself, and send this information directly to the network.

In the above embodiments reference has been made to a time during which the UE is able to perform the one or more operations. In accordance with embodiments, this time may be indicated as a certain percentage of a certain time duration, like a transmit time or a receive time. This means that during a certain time duration, like the transmit time, UE 400 may not be capable to provide over the entire duration sufficient energy for performing a certain operation, like sending bursts of data or receiving data, rather, this may only be possible during a certain fraction or percentage of the time duration. UE 400 may charge itself via the external charge 424 or the harvester 426, however, the available power may not be high enough to run complex operations over the entire or whole time, like the entire transmit time. Hence, UE 400 may only perform an operation for a certain duration or part of the time and then has to wait for a certain duration until the required power/energy level is reached again. In accordance with other embodiments, rather than indicating a certain percentage of the certain time duration, also a ratio between an operating time of the UE, i.e., the time during which the UE is actually able to perform the operation, and a recovering time of the UE is indicated, namely the time during which the battery 420 is charged to a sufficient power or energy level by the charger 424 or the harvester 426 to perform the operation.

In accordance with other embodiments, UE 400 may signal how long the charger/harvester 424/426 is able to sustain a certain power or energy level needed for performing a certain operation. For example, when considering again the above-mentioned certain time duration, like a transmit time, a certain fraction or percentage of this time may be indicated which, in this embodiment, signals to the other entities that for this percentage of time sufficient energy is available at the UE 400 for performing the desired operation. Likewise, also a ratio between the operational time during which the charger/harvester 424/426 sustains the required power or energy level in the battery 420 and a recovering time may be indicated during which the charger/harvester 420 charges the battery 420.

In accordance with further embodiments, UE 400 may signal to the network entities a maximum, minimum, or average UE power or energy consumption level, like an average power consumption over a certain configured or preconfigured time window or for a certain configured or preconfigured operation, like for performing a transmission burst. Based on this information, namely the consumption level, the network entity may judge, together with further knowledge about the capacity of the battery 420, whether further operations of the same power consumption level are possible or whether it is more likely that the battery power/energy level dropped to a level at which such operations are no longer possible. This allows the network entities to control operation of the UE 400 in such a way that for any required operations efficient energy is available at the UE400.

In the embodiments described above, reference has been made, quite generally, to the UE 400 requiring a certain amount of power or energy to perform a certain operation. In accordance with embodiments, the one or more operations to be performed by the UE may include the following, but are not limited to such operations:
Transmitting to one or more entities of the wireless communication system, for example performing a data transmission via the Uu interface 416, i.e., an uplink, to the gNB 412, or performing a sidelink transmission on the PC 518 to UE 414.
Receiving from the one or more entities of the wireless communication network, for example a downlink transmission on the Uu interface 416, or a sidelink transmission from UE 414 to UE 400.
Performing one or more measurements of the environment of the UE, like beam failure detection, BFD, measurements, intra-frequency radio resource management, RRM, measurements, inter-frequency, RRM, measurements, channel state indicator, CSI, measurements.
Sending bursts of data and receiving data to/from one or more of the network entities 412, 414.
Performing sensing operations, for example in case UE 400 operates as a mode 2 UE, i.e., receives no scheduling information for a sidelink communication from gNB 412 and performs sensing operations, for example on the physical sidelink control channel, PSCCH, to find available resources for a communication with SL-UE 414.
Processing feedback channels, like the physical sidelink feedback channel, PSFCH, for a sidelink communication.
One or more paging operations, for example for paging in a sidelink communication one or more further sidelink UEs.
Decoding one or more control channels, like the physical downlink control channels PDCCHs, or the physical sidelink control channel, PSCCHs.

In the embodiments described above, it has been indicated that the UE 400 communicates with the gNB 412, however, the present invention is not limited to such embodiments. Rather, UE 400 may also be a sidelink, SL, UE that communicates directly using the sidelink or PC5 interface 418, with a further sidelink UE 414. UE 400 may operate either in mode 1 in accordance with which it receives the scheduling information regarding the resources to be used for the sidelink communication from gNB 412, or it may operate in mode 2 and perform an autonomous sensing operation for determining available resources in a sidelink resource pool for a communication with the other sidelink UEs.

### Adaptinq UE Procedures

As described above with reference to FIG. 3, in addition to providing information about the fact that UE 400 includes a mains-independent power source 404 and besides providing information about the status of the power source 404, in accordance with further embodiments, UE 400 may also adapt one or more procedures to be implemented in UE 400 dependent on a status of the mains-independent power source 404. In accordance with embodiments, the procedures may include one or more of the following:
a discontinuous reception, DRX, procedure,
a paging procedure,
a control channel monitoring procedure, like physical downlink control channel, PDCCH, monitoring or physical sidelink control channel, PSCCH, monitoring,
a measurement procedure.

### Adjustment of the DRX Procedure/Paging Procedure

For UEs with a limited or finite power supply, like UE 400 including a battery 420 that needs to be recharged regularly by connection to the external power source 424 or by the harvester 426, since they are not connected to a constant power supply but rely on their battery, power saving is important. Such UEs may include so-called vulnerable road users, VUEs, like a pedestrian UE, P-UE, or first responder devices for public safety use cases, or IoT devices, like general IoT UEs or industrial IoT UEs. For these types of UEs.

To reduce the power consumption at a UE in NR, the discontinuous reception, DRX, is employed on the Uu interface 416 and on the sidelink 418. For NR, for example, further details of the DRX operation on the Uu interface 416 are defined in 3GPP TS 38.321. DRX is a mechanism where the UE 400 goes into a sleep mode for a certain period of time, during which it does not transmit or receive any data. UE 400 wakes up for another period of time, where it may transmit and receive data.

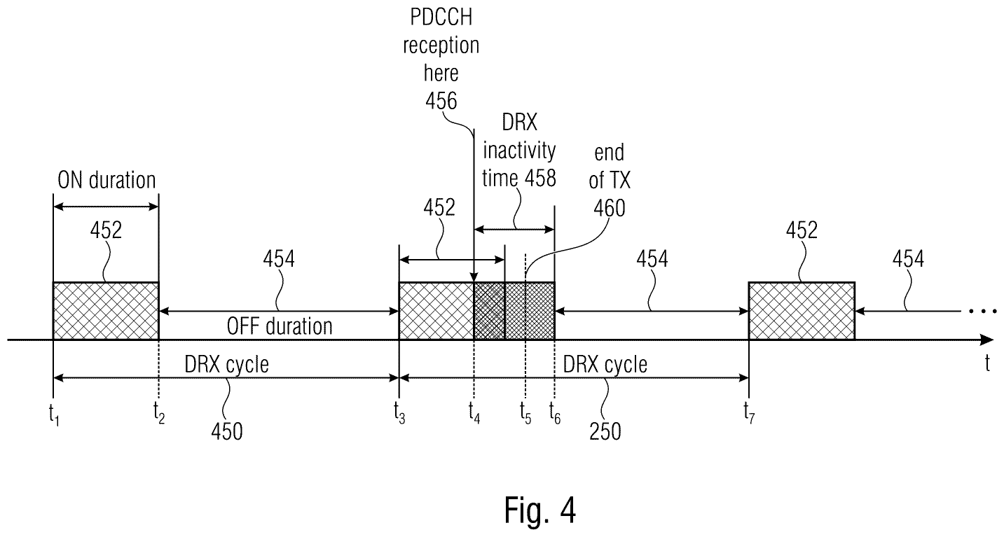

FIG. 4 illustrates a DRX mode using an inactivity timer. The DRX configuration defines a DRX cycle 450 spanning a certain time and including an on period or ON duration 452 at the beginning of a DRX cycle, followed by an off period or OFF duration 454. The UE is awake or active during the ON durations 452, and, whenever a transmission or a packet is received during an ON duration, the so-called inactivity timer, is started. The inactivity timer may specify the number of consecutive control messages for which the UE may be active after successfully decoding of a control message that indicates a new transmission, with the following configuration:
the timer is restarted upon receiving a control message for a new transmission and/or any other control message which is addressed to the UE, e.g., scrambled by UE-specific RNTI or group-specific RNTI, or when receiving a corresponding signaling, e.g., from a group leader UE from a base station or from a relay node or from a road side unit, RSU,
upon the expiry of the timer, the UE goes to DRX mode or OFF time.

In FIG. 4, the reception of a data packet is indicated at 456 during the ON duration 452 of the DRX cycle that starts at time t3. For example, a DCI 456 may be received by the UE on the PDCCH which, in turn, triggers the inactivity timer to be started thereby adding the DRX activity time 458 so that the original ON duration 452 as defined by the DRX configuration is extended from the time t4 to the time t6. This enables a transmitter to send further data associated with the DCI 456 on the PSCCH. In case a transmitter does not intend to send any further data, it may send a DRX command to put the UE into the inactive mode or into the sleep mode. For example, at any time during the inactivity timer duration 458 the UE may receive a DRX command indicating that no further data is to be expected from the transmitter or that the transmitter does not send any further data. Responsive to receiving such an end of transmission signaling 460, for example at a time t5 that is before the end t6 of the inactivity timer duration 458, the UE may return into the sleep mode. It is noted that the end of transmission signaling 460 may also be received for a transmission that does not trigger the inactivity timer so that a regular ON duration 452, as defined by the DRX communication, responsive to the signaling 460 may be terminated before the configured end of the ON duration 452. Such an approach may be implemented booth for the Uu interface 416 and for the sidelink interface 418.

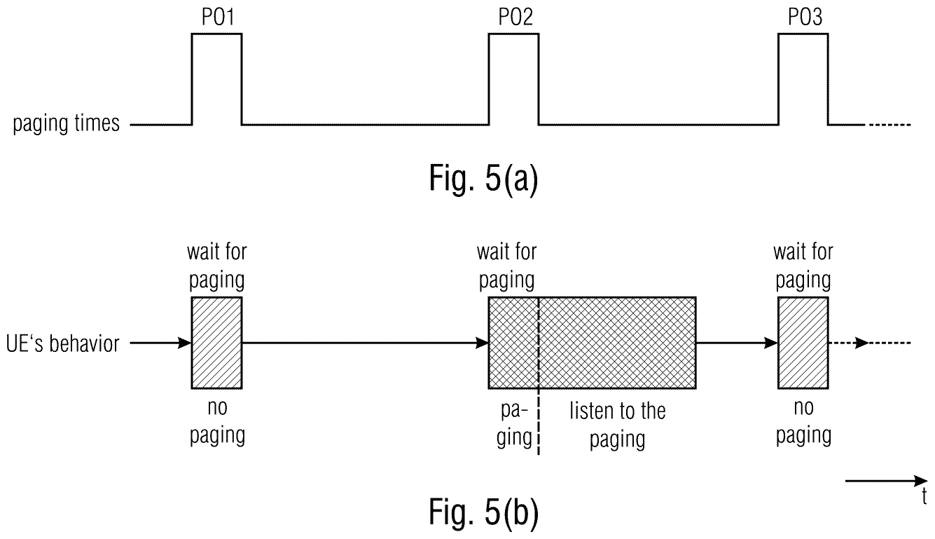

During the ON durations 452, e.g., at the beginning thereof, UE 400 may monitor a control channel for paging occasions, Pos. FIG. 5 illustrates a paging mechanism. FIG. 5(a) illustrates a number of paging occasions, PO, existing during a certain period of time. FIG. 5(b) illustrates the behavior of UE 400 at such paging occasions. UE 400 may monitor each of the paging occasions PO1 to PO3 to listen for possible paging signals for UE 400, i.e., UE 400 periodically, during the ON durations 452, listens for possible paging signals associated with UE 400 at the paging occasions PO1, PO2 and PO3. In FIG. 5, it is assumed that at paging occasions PO1 and PO3 no paging message or paging signal for UE 400 is transmitted. However, at paging occasion PO2, UE 400 recognizes a paging message or paging signal for the UE and continues to listen to the paging signal, e.g., by activating the inactivity timer.

In accordance with embodiments, UE 400 may adapt the DRX/paging procedure dependent on how long it takes to recharge the energy storage to a level which allows the UE to operate, for example to perform a certain operation. In other words, UE 400, in general, starts or performs a certain operation only in case a power or energy level provided by the battery 420 is at or above a configured or preconfigured threshold that is necessary for reliably performing or completing the operation in question. Performing such an operation, naturally, consumes power from battery 420, and in accordance with embodiments the DRX procedure and/or the paging procedure is adapted dependent on the so-called recovery time of the battery 420. The recovery time is the time required, after performing one or more operations which consumed energy from battery 420, for charging the battery 420, either by connecting it to the external power source 424 or by operating the harvester 426, back to a power or energy level that is sufficient for the UE to become active, i.e., to perform a certain operation.

In accordance with embodiments of the present invention, UE 400 may consider a recovery time of the battery 420 in such a way that one or more DRX occasions and/or paging occasions that occur after the operation that drained the battery 420 was completed and that occurred during the recovery time of the battery 420 are skipped. For example, when considering FIGS. 4 and 5, at the second DRX occasion/second paging occasion, the UE 400 performed a certain operation like a reception or transmission of data which may result in the battery power 420 going below a needed energy or power level, and it is assumed that the recovery time for charging the battery 420, by means of the harvester 426 or by connecting it to the external power source 424, back to a sufficient energy/power level exceeds beyond the third DRX occasion/paging occasion PO3 so that these occasions are skipped.

In accordance with embodiments, UE 400 may report the skipping of the DRX occasion and/or paging occasion to the gNB 412 or to the SL-UE 414. For example, when reporting the skipping of the respective occasions to the gNB 412 or to a core network entity, UE may report this skipping by using the random access channel, RACH. In accordance with other embodiments, instead of signaling each skipped occasion separately to the respective network entities, UE 400 may collect all occasions skipped by UE 400 during the recovery time and, once the battery 420 is charged back to the needed energy/power level, UE 400 may report the skipped occasions to the network entity. The network may determine from the skipping pattern how long the UE needs to recover and adapt DRX and/or paging occasions accordingly.

In accordance with embodiments, skipping the respective occasions may include indicating the actual number of skipped occasions to the network, or indicating a time since a first occasion was skipped or since the last occasion was skipped, or indicating a bitmap of DRX occasions where the skipped or monitored DRX occasions are indicated, e.g., a bitmap being represented as a dense vector, or a bitmap being represented as a sparse vector. From the number of skipped occasions or the time of the first skip the network may determine a duration that it takes the UE to recover from previous monitoring times and adapt the DRX and/or paging procedures accordingly.

In accordance with further embodiments, the UE 400 may modify the DRX procedure by changing the DRX ON/OFF durations dependent on a charging state or health status of the battery 420 or the power supply 404. UE 400, responsive to determining or estimating that the charge status or health status that is at or below a certain threshold, performs one or more of the following actions:
shorten a DRX ON duration and/or an inactivity timer,
increase a DRX OFF duration,
transmits a charging state of the battery 420.

By shortening the DRX ON duration/increasing the DRX OFF duration, UE 400 reduces the number of resources to monitor for a signaling directed to the UE, like a paging, and by shortening the inactivity timer, also a duration is reduced during which the UE stays on after a paging occasion at the beginning of a DRX ON duration, thereby lengthening the time during which the UE is in the OFF duration during which the charger/harvester 424/426 may charge the battery 420 to a needed energy/power level. By signaling or transmitting the charging state of the battery 420, a gNB may determine or estimate that the UE 400 operating in accordance with the principles of the present invention and shortened its DRX ON duration/increased its DRX OFF duration by a known amount. Thereby the gNB may adapt the times at which a paging occasion is actually transmitted so as to avoid a waste of resources which are not monitored by UE 400 because of the reduced energy/power level available from battery 420.

In accordance with yet other embodiments, in case the health status or the charging state of the battery 420 of UE 400 is at or below a configured or preconfigured threshold, UE 400 may change from the mobile initiated communication, MICO, mode to a network initiated, NICO, mode. In the NICO mode, UE 400 is activated only by providing a wakeup signal, for example from the gNB 412 or via the PC 5 interface 418 from UE 414, during the DRX ON duration so that UE 400 does not waste any power in case it suffers from a bad battery condition, like a charging level below a certain threshold, which is in contrast to the MICO mode, which is mobility initiated. For this, the network may put one or more UEs in a low-power mode, and configure the UEs, e.g., by using a timer, to check for a wakeup signal (WUS) at a certain point in time and/or at certain time intervals and/or at certain regular time intervals. Furthermore, in case a NICO mode is not supported by the network, the MICO mode may be enhanced by configuring certain synchronized re-registration timers, which trigger the UE to wake up in certain time intervals.

In accordance with yet further embodiments, UE 400 may modify the DRX ON/OFF duration in such a way that the DRX ON duration 452 is prolonged by triggering the DRX inactivity timer only in case a certain condition of the battery 420 is fulfilled, for example in case an energy or power level is above a configured or preconfigured threshold. In other words, in case the battery 420 yields a power or energy level that is short of the configured or preconfigured threshold, the DRX inactivity timer is not triggered so that UE 400 remains active only during the ON duration and the OFF duration is not shortened, as is shown at the center of FIG. 4, so that more time remains for the charger/harvester 424/426 to recharge the battery 420 to the desired power level. In accordance with embodiments, UE 400 may signal to the network that an extension of the DRX ON duration is not carried out or that the triggering of the DRX inactivity timer is not performed, thereby allowing the network to configure any transmissions or operations to be performed by UE 400 responsive to an activation during the ON duration such that they do not extend beyond the original end of the ON duration 452, thereby avoiding any loss of information being transmitted and giving the UE 400 sufficient time for recharging the battery 420.

Regarding the recovery time, in accordance with embodiments UE 400 may determine the recovery time by itself or, in accordance with other embodiments, the recovery time may be estimated at the network side, for example by the gNB or by a core network entity, and forwarded to the UE 400 which, then, in response to the received recovery time, adapts the DRX/paging procedure in a way as described above.

### Adjustment of Control Channel Monitoring Procedure

In accordance with further embodiments of the present invention, dependent on the status of the main independent power source 404 of UE 400, UE 400 may select a certain minimum control channel monitoring capability, like a minimum and/or maximum PDCCH or PSCCH monitoring capability. In accordance with embodiments, UE 400 may determine the minimum control channel monitoring capability on the basis of information about the status of its mains-independent power source 404 and report the determined minimum control channel monitoring capability to the one or more entities of the wireless communication system. In accordance with other embodiments, the minimum control channel monitoring capability may be determined by one or more of the network entities, for example on the basis of the information the respective entities received about the status of the power source 404 from UE 400. The determined minimum control channel monitoring capability is returned to UE 400.

In accordance with embodiments, one or more of the following properties of the minimum or maximum control channel monitoring capability may be modified dependent on the status of the power source 404 or battery 420 of UE 400.
The periodicity of the control channel monitoring may increase/decrease with
   an increase/decrease of the length of the DRX on duration, and/or
   with an increase/decrease of the duration of the DRX inactivity timer.
For example, a longer DRX on duration means more PDCCH monitoring occasions at the same monitoring periodicity. Hence, for a longer duration, UE 400 may be able to perform only a certain number of PDCCH monitorings and requires a higher PDCCH monitoring periodicity.
A number of control channel monitoring occasions increases/decreases with an increase/decrease of the recovery rate or recovery time of the battery 420. For example, a UE having a higher recovery rate may be able to recover from a last PDCCH monitoring occasion and, hence, may support more PDCCH monitoring occasions in the DRX on duration.
A number of control channel monitoring occasions and/or a number of schedulings per DRX ON duration may depend on a charging state or a health status of the battery 420. For example, when the charging state or the health status of the battery 420 is at or below a certain threshold, UE may change to the NIC mode, as explained above.

In accordance with other embodiments, for adjusting a control channel monitoring procedure, UE 400 may deactivate one or more search spaces. UE 400 monitors a plurality of search spaces for the control channel monitoring occasions. The search space, like a CORSET, may include one or more resources on which the network transmits control information for the respective UEs served by a base station. By monitoring the search space UE 400 may determine a control message that is directed to UE 400. In accordance with embodiments, if a charging state, like a power or energy level of the battery 420 drops under a certain configured or preconfigured threshold, UE 400 may deactivate the monitoring of one or more of the search spaces for control channel monitoring occasions, thereby reserving time, for example, for operating the charger/harvester 424/426 to recharge battery 420. The deactivated search spaces may be signaled to the network so as to avoid, for example, that gNB 412 sends control information directed to UE 400 to a search space or on resources of a search space which are no longer monitored by UE 400. In accordance with embodiments, UE 400 may deactivate the monitoring of the search spaces in accordance with a configured or preconfigured deactivation order. For example, the search spaces may be ordered according to their priority. The priority may be determined based on certain rules at the UE, e.g., type of search space, DCI formats to monitor, or it may be configured by the network, e.g., search space index, or it may be determined based on the order of configuration, e.g., first configured search spaces have an higher priority than later configured search spaces. In accordance with further embodiments, more than one deactivation order may be provided and UE 400 may select one of the available deactivation orders while considering the power or energy consumption level so that, for example, depending on the energy/power status the UE may monitor certain search space subsets given by the deactivation order. In particular, that may mean that at a moderate power the UE may still monitor two search space per DCI format 1_1 and 1_2 but if the power drops a bit it may prefer monitoring three search spaces for DCI format 1_1 but no search space for format 1_2, and if the power drops even further it may go down to only one search space for DCI format 1_1.

In accordance with yet further embodiments, UE 400 may inform the network about a situation in which it needs to recover energy, for example by informing the network about the status of the power source 404 in a way as described in detail above, and, responsive to such a signaling, UE 400 may receive a certain control channel skipping configuration or one or more new search spaces to monitor for control channel monitoring occasions which are provided such that the UE is given time to recharge battery 420. For example, a new search space may be an existing search space having an increased periodicity and providing for less blind decoding attempts. For example, when providing a certain control channel skipping configuration to UE 400 a number of occasions that UE 400 has to monitor may be reduced so that the time duration between respective ON durations, like DRX ON durations, is increased, thereby giving the UE more time to recharge the battery 420.

### Adjustment of Measurement Procedures

In accordance with yet other embodiments, UE 400 may adjust one or more measurement procedures dependent on a status of the power source 404. For example, UE 400 may deactivate one or more measurements, like a secondary cells, SCell, measurement, and/or deactivate or reduce a frequency of measurement reporting dependent on the charging state of the battery 420. For example in case it drops under a certain configured or preconfigured threshold, the number of reports may be decreased or an interval between reports may be increased.

In accordance with embodiments, UE 400 may deactivate the one or more measurements and/or reportings in accordance with a configured or preconfigured deactivation order. Embodiments allow UE to choose a deactivation order from a plurality of configured or preconfigured deactivation orders. For example, each deactivation order may be such that measurements are deactivated dependent on the power/energy requirements of the measurements so that, for example, initially the highest power consuming measurements are deactivated, for example in a step-wise manner downwards to a lower-most consumption level. In accordance with other embodiments, initially, also measurements may be deactivated in accordance with a certain priority the measurements have associated therewith so that, initially, low priority measurements may be deactivated before higher priority measurements.

UE 400 may signal the deactivation of the one or more measurements to the network, thereby specifying either which measurements the UE 400 is still able to perform and/or which measurements the UE is not able to perform, at least at an actual condition of the battery device 420. This information allows the network, like gNB 412 or SL-UE 414 to configure UE 400 only with measurements the UE is capable to confirm given the actual charging status of the battery 420. Moreover, given the information from the UE 400, the network does not expect receiving measurement results for certain measurements already triggered by the network to be performed by UE 400. In accordance with further embodiments, responsive to an indication which measurements UE 400 is able to perform/not to perform, the UE may receive a list of measurements and/or reports to be activated and/or deactivated at the UE 400, or a list of relaxation measures, like a reduced frequency of performing the measurements and/or the reporting, or for one or some or all types of measurements an individual new measurement configuration, being adapted to the actual power situation at UE 400. The types of measurements may include the above mentioned BFD measurements, intra-frequency RRM measurements, inter-frequency RRM measurements and CSI measurements.

### Base Station

In accordance with further embodiments of the present invention, a base station is provided that receives from a UE having a mains-independent power source assistance information indicating the UE to be mains-independent and/or a status of the power source of the UE. It may use the assistance information for controlling a communication/operation of the UE. FIG. 3 illustrates the base station 412 for a wireless communication system in accordance with embodiments of the present invention. As is indicated in FIG. 3, gNB 412 serves one or more user devices, like UE 400 and UE 414 as schematically indicated by the Uu interfaces 416, 428. One or more of the UEs may be a UE having a mains-independent power source for a signal processor of the UE to provide power to the signal processor for performing one or more operations. In other words, gNB 412 may serve a UE 400 in accordance with embodiments of the present invention as described above in detail. gNB 412 receives from UE 400 a status of its mains-independent power source 404 and/or that UE 400 is a device having such a mains-independent power source 404. The gNB 412 considers this information for coordinating a communication of the UE 400 and/or for controlling an operation of the UE 400.

In accordance with embodiments, gNB 412 may adapt one or more of the following:
The scheduling of certain transmissions, like the transmission of a wake-up signal or a paging signal. For example a frequency with which a wake-up signal or a paging signal is transmitted to UE 400 may be adapted. On the basis of the information, the gNB 412 may determine that UE 400 skips certain monitoring occasions so that sending a wake-up signal or a paging signal at such an occasion, which is no longer monitored by UE 400, is a waste of energy or resources.
The resources to be used for transmitting control information. For example, control information be may be conveyed only on resources of a search space, like a CORSET, which the gNB expects to be actually monitored by UE 400.
Operations concerning the UE 400 may be configured such that, for example, UE 400 has to perform a reduced number of blind decoding attempts to allow the UE to last longer.
Configured grants or sidelink resources, like a resource pool, or the sensing modes and other grants, may be controlled by gNB 412 dependent on the information received from UE 400 concerning the status of the battery 420. For example, the network may increase the period of Configured Grants, or adapt the resource pool configuration allowing for partial sensing which lowers the sensing burden on the UE. Furthermore, the network may tell the UE to apply random resource selection instead of performing sensing at all.

Moreover, responsive to the received information, the gNB 412 may adapt certain procedures that are implemented for UE 400, for example, the DRX procedure, the paging procedure, the control monitoring procedure and the measurement procedure so as to adapt a configuration at the gNB 412 to any change performed by the UE 400.

For example, gNB 412 may perform one or more of the following actions:
receive from the UE a report of the one or more criteria, determine a minimum control channel monitoring capability, and signal the determined minimum control channel monitoring capability to the UE,
receive from the UE a signaling indicating that the UE is to recover energy, determine a control channel skipping configuration or one or more new search spaces to be monitored for control channel monitoring occasions, and signal the control channel skipping configuration or the new search space to the UE, thereby giving the UE time to recharge,
receive from the UE a report which specifies which measurements the UE is able to perform further and/or which measurements the UE is not able to perform further at a current condition of the energy storage device, and determine and forward to the UE one or more of the following:
   a list of measurements and/or reports to be activated and/or deactivated,
   a list of relaxation measures, like a reduced frequency of measurements and/or reports,
   for one or some or all types of measurements an individual new measurement configuration.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

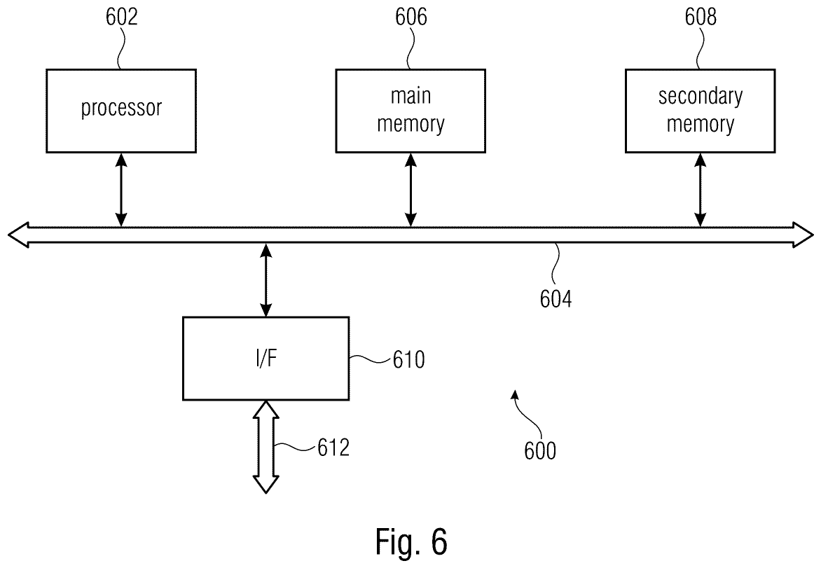

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 6 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication system, comprising:
one or more antennas,
a signal processor connected to the antenna, wherein the signal processor is to perform one or more operations, and
a mains-independent power source connected to the signal processor to provide power to the signal processor for performing the one or more operations,
wherein the UE is to
signal to one or more entities of the wireless communication system information indicating
a status of the mains-independent power source, and/or
that the UE is a device comprising a mains-independent power source, and/or
adapt one or more of operational procedures dependent on a status of the mains-independent power source.

2. The user device, UE, of claim 1, wherein the UE is to signal the information
at configured or preconfigured times, e.g. when connecting or re-connecting to the wireless communication system, and/or
with a configured or preconfigured periodicity, and/or
in response to one or more configured or preconfigured criteria, and/or
in response to a request from one or more entities of the wireless communication system, like a base station or another UE.

3. The user device, UE, of claim 1, wherein the information indicating the status of the mains-independent power source comprises one or more of the following:
a power or energy level the mains-independent power source is able to provide for powering the signal processor to perform the one or more operations,
that the mains-independent power source is not able to provide a first power or energy level required for powering the signal processor to perform the one or more operations,
that the mains-independent power source is not able to provide a first power or energy level required for powering the signal processor to perform the one or more operations but only a second power or energy level that is lower than the first power or energy level,
that the mains-independent power source is able to provide the first power or energy level required for powering the signal processor to perform the one or more operations only for a certain time period,
that a power or energy level the mains-independent power source is able to provide is at or below a configured or preconfigured threshold and that the UE enters a configured or preconfigured low power mode,
a health status of the mains-independent power source,
an estimated remaining mains-independent power source time indicating how long the UE is expected to be able to perform the one or more operations, e.g., to stay active,
a critical power state causing the UE to enter a pre-configured low power mode

4. The user device, UE, of claim 1, wherein the health status of the mains-independent power source comprises one or more of the following:
an age of the mains-independent power source, like a manufacturing date,
a ratio of the maximum power that the mains-independent power source is still capable to deliver, e.g., due to corruption or aging effects,
a full charge capacity of the mains-independent power source, indicated, e.g., by a percentage of a known maximum charge capacity,
a number of charging cycles performed by the mains-independent power source,
a number of charging cycles left for the mains-independent power source, e.g., a charging countdown,
a usage of the mains-independent power source, e.g., an average current, power or voltage, a maximum current, power or voltage, a minimum current, power or voltage,
an indication that the UE is no longer able to perform at a predefined performance, like a peak performance, e.g., due to a current charge of the mains-independent power source, a current temperature of the mains-independent power source an age of the mains-independent power source.

5. The user device, UE, of claim 1, wherein the mains-independent power source comprises an energy storage device.

6. The user device, UE, of claim 1, wherein the energy storage device, e.g., a battery or an accumulator, is chargeable by connecting the energy storage device to an external charging device.

7. The user device, UE, of claim 6, wherein the information indicating the status of the mains-independent power source comprises one or more of the following:
a recovery of the energy storage device,
a time for which the UE is able to perform the one or more operations, like an active time of the UE.

8. The user device, UE, of claim 1, wherein the UE is an energy harvesting UE and comprises an energy harvesting device for charging the energy storage device, e.g., a battery or an accumulator or a capacitor, without the need to connect the energy storage device to an external charging device.

9. The user device, UE, of claim 8, wherein the energy harvesting device comprises one of more of the following:
a device for harvesting energy from motion, like a mechanical energy converter such as a piezoelectric generator or a dynamo or an alternator or a generator or a small windmill,
a device for harvesting energy from radiation, like a solar module,
a device for harvesting energy from chemical reactions, like a small hydrogen fuel cell,
a device for harvesting energy from a radio signal, like the radio signal from the base station or another UE in the proximity
a device for harvesting energy from temperature differences, like a Peltier element.

10. The user device, UE, of claim 8, wherein the information indicating the status of the mains-independent power source comprises one or more of the following:
a recovery of the energy storage device,
a time for which the UE is able to perform the one or more operations, like an active time of the UE or an inactive time of the UE.

11. The user device, UE, of claim 10, wherein the recovery comprises one or more of the following:
a recovery rate of the energy storage device which indicates how fast the energy harvesting device is able to recharge or recover the energy storage device to provide a power or energy level allowing the UE to perform the one or more operations,
a recovery time or rate of the energy storage device, e.g., active Rx seconds or Tx seconds recovered per hour or the ratio between active Rx seconds and Tx seconds, which indicates a time the energy storage device requires to
recover from a last operation to provide a power or energy level allowing the UE to perform the one or more operations, or
reach a configured or preconfigured power or energy level.

12. The user device, UE, of claim 10, wherein the UE is to estimate the recovery of the energy storage device using one or more of the following:
a current harvesting current or power provided by the energy harvesting device,
a minimum harvesting current or power provided by the energy harvesting device,
an average energy harvesting current or power provided by the energy harvesting device over a certain configured or preconfigured time window.

13. The user device, UE, of claim 10, wherein the UE is to report one or more operating parameters of the energy harvesting device to a network entity, like a base station or another UE, for allowing the network entity to estimate the recovery of the energy storage device, the operating parameters comprising one or more of the following:
a current harvesting current or power provided by the energy harvesting device,
a minimum harvesting current or power provided by the energy harvesting device,
an average energy harvesting current or power provided by the energy harvesting device over a certain configured or preconfigured time window.

14. The user device, UE, of claim 10, wherein the time for which the UE is able to perform the one or more operations indicates one or more of the following:
a percentage of a certain time duration, like a transmit time or a receive time, for which the energy storage device, like a capacitor, is able to provide a certain power or energy level that allows the UE to perform the one or more operations, like sending bursts of data and receiving data,
a ratio between an operational time of the UE during which the UE performs the one or more operations, and a recovering time of the UE during which the energy storage device is charged to a power or energy level allowing the UE to perform the one or more operations,
a percentage of a certain time duration, like a transmit time or a receive time, for which the energy harvesting device is able sustain a certain power or energy level in the energy storage device that allows the UE to perform the one or more operations,
a ratio between an operational time during which the energy harvesting device is able sustain a certain power or energy level in the energy storage device that allows the UE to perform the one or more operations, and a recovering time during which the energy harvesting device charges the energy storage device to a power or energy level allowing the UE to perform the one or more operations.

15. The user device, UE, of claim 1, wherein the UE is to signal to the one or more entities of the wireless communication system a UE power or energy consumption level, like an average power consumption over a certain configured or preconfigured time window, or for a certain configured or preconfigured operation, e.g., a transmission burst.

16. The user device, UE, of claim 1, wherein the one or more operations comprise one or more of the following:
transmitting to the one or more entities of the wireless communication system,
receiving from the one or more entities of the wireless communication system,
performing measurements of an environment of the UE,
sending bursts of data and receiving data,
sensing, e.g., a physical sidelink control channel, PSCCH,
processing feedback channels, e.g., a physical sidelink feedback channel, PSFCH,
one or more paging operations,
decoding one or more control channels, like Physical Downlink Control Channels, PDCCHs, or Physical Sidelink Control Channels, PSCCHs.

17. The user device, UE, of claim 1, wherein the UE is to adapt one or more of the following procedures dependent on a status of the mains-independent power source:
a Discontinuous Reception, DRX, procedure,
a paging procedure,
a control channel monitoring procedure, like a Physical Downlink Control Channel, PDCCH, or a Physical Sidelink Control Channel, PSCCH,
a measurement procedure.

18. The user device, UE, of claim 17, wherein:
the UE is to start or to perform the one or more operations when a power or energy level provided by the energy storage device is at or above a configured or preconfigured threshold, and
dependent on a recovery time required, after completing the one or more operations, for charging the energy storage device, e.g., by an energy harvesting device, to a power or energy level at or above the configured or preconfigured threshold, the UE is to adapt one or more of the following procedures:
a Discontinuous Reception, DRX, procedure,
a paging procedure.

19. The user device, UE, of claim 18, wherein the UE is to skip one or more DRX occasions and/or paging occasions which, after completing the one or more operations, occur during the recovery time.

20. The user device, UE, of claim 19, wherein the UE is to report the skipping of a DRX occasion and/or a paging occasion to one or more entities of the wireless communication system, like a base station or a core network entity, e.g., by using a Random Access CHannel, RACH, or by collecting skipped DRX occasions and/or paging occasions and reporting once the energy storage device is charged to a power or energy level at or above the configured or preconfigured threshold.

21. The user device, UE, of claim 20, wherein reporting the skipping of DRX occasions and/or a paging occasions comprises one or more of the following:
a number of skipped DRX occasions or paging occasions,
a time since a first or a last skipped DRX occasion or paging occasion,
a bitmap of DRX occasions where the skipped or monitored DRX occasions are indicated, e.g., a bitmap represented as a dense vector, or a bitmap represented as a sparse vector.

22. The user device, UE, of claim 18, wherein, in case a charging state or a health status of the energy storage device is at or below the configured or preconfigured threshold, the UE is to perform one or more of the following actions:
shorten a DRX ON duration and/or inactivity timer,
increase a DRX OFF duration,
transmit the charging state of the energy storage device to one or more entities of the wireless communication system, like a base station or a core network entity.

23. The user device, UE, of claim 18, wherein, in case a health status of the energy storage device is at or below the configured or preconfigured threshold, the UE is to change from a mobile initiated communication, MICO, mode to a network initiated communication, NICO, mode.

24. The user device, UE, of claim 18, wherein the UE is to prolong the DRX ON duration by triggering a DRX inactivity timer only if a certain condition of the energy storage device is fulfilled, e.g., a power or energy level is above a configured or preconfigured threshold.

25. The user device, UE, of claim 24, wherein, in case the condition is not fulfilled, the UE is to signal to one or more entities of the wireless communication system that the DRX ON duration is not prolonged or that the DRX inactivity timer is not triggered.

26. The user device, UE, of claim 18, wherein the UE is to
determine the recovery time, or
receive the recovery time from one or more entities of the wireless communication system, like a base station or a core network entity.

27. The user device, UE, of claim 17, wherein the UE comprises a certain minimum control channel monitoring capability, like a minimum and/or maximum PDCCH or PSCCH monitoring capability, the certain minimum and/or maximum control channel monitoring capability depending on the status of the mains-independent power source.

28. The user device, UE, of claim 27, wherein the UE is to report the status of the mains-independent power source to one or more entities of the wireless communication system, like a base station, and receive the minimum and/or maximum control channel monitoring capability from the entity of the wireless communication system.

29. The user device, UE, of claim 27, wherein the UE is determine the minimum control channel monitoring capability using the status of the mains-independent power source, and report the determined minimum control channel monitoring capability to one or more entities of the wireless communication system, like a base station.

30. The user device, UE, of claim 27, wherein the minimum control channel monitoring capability comprises one or more of the following:
a control channel monitoring periodicity that increases/decreases with an increase/decrease of the length of the DRX ON duration,
a control channel monitoring periodicity that increases/decreases with an increase/decrease of the duration of the DRX inactivity timer,
a number of control channel monitoring occasions that increases/decreases with an increase/decrease of a recovery rate or a recovery time of the energy storage device,
a number of control channel monitoring occasions and/or a number of schedulings per DRX ON duration that depends on a charging state or a health status of the energy storage device, like a battery level, wherein charging state or a health status of the energy storage device at or below the configured or preconfigured threshold, causes the UE to change from a mobile initiated communication, MICO, mode to a network initiated communication, NICO, mode.

31. The user device, UE, of claim 27, wherein
the UE is to monitor a plurality of search spaces for control channel monitoring occasions, and
the UE is to deactivate monitoring one or more of the plurality of search spaces for control channel monitoring occasions, if a charging state, like a power of energy level, of the energy storage device drops under a certain configured or preconfigured threshold.

32. The user device, UE, of claim 31, wherein the UE is to deactivate monitoring the search spaces in accordance with a configured or preconfigured deactivation order.

33. The user device, UE, of claim 32, wherein the UE is to choose a deactivation order from a plurality of configured or preconfigured deactivation orders under consideration of a power or energy consumption level.

34. The user device, UE, of claim 27, wherein the UE is to inform one or more entities of the wireless communication system, like a base station, that the UE is to recover energy, and receive from the entity of the wireless communication system a control channel skipping configuration or one or more new search spaces to monitor for control channel monitoring occasions, thereby giving the UE time to recharge.

35. The user device, UE, of claim 17, wherein, if the charging state of the energy storage device drops under a certain configured or preconfigured threshold, the UE is to
deactivate one or more configured or preconfigured measurements, like a secondary cell, SCell, measurement, and/or
deactivate or reduce a frequency of measurement reporting to one or more entities of the wireless communication system, like a base station, e.g., a channel state information, CSI, reporting.

36. The user device, UE, of claim 35, wherein the UE is to deactivate the one or more measurements and/or reports in accordance with a configured or preconfigured deactivation order,

37. The user device, UE, of claim 36, wherein the UE is to choose a deactivation order from a plurality of configured or preconfigured deactivation orders.

38. The user device, UE, of claim 35, wherein the UE is to send a report to the one or more entities of the wireless communication system, like a base station, which specifies which measurements the UE is able to perform further and/or which measurements the UE is not able to perform further at a current condition of the energy storage device, like a current power or energy level or a current recovery rate or time.

39. The user device, UE, of claim 38, wherein, responsive to the report, the UE is to receive from the entity of the wireless communication system one or more of the following:
a list of measurements and/or reports to be activated and/or deactivated,
a list of relaxation measures, like a reduced frequency of measurements and/or reports, or a relaxation of one or more processing times for the signal processor, e.g. due to a clock reduction;
for one or some or all types of measurements an individual new measurement configuration.

40. The user device, UE, of claim 39, wherein the report comprises a bit map and refers to measurement features such as one or more of the following:
Radio Link Monitoring, RLM, measurements,
Beam Failure Detection, BFD, measurements,
intra-frequency Radio Resource Management, RRM, measurements,
inter-frequency RRM measurements,
CSI reporting, and
wherein the report, optionally, also comprises an indication if the UE considers itself stationary, e.g., based on one or more internal sensors or based on a positioning procedure.

41. A base station for a wireless communication system,
wherein the base station is to serve one or more user devices, UEs, wherein the UE comprises a mains-independent power source for a signal processor of the UE to provide power to the signal processor for performing one or more operations,
wherein the base station is to receive from the UE information indicating
a status of the mains-independent power source, and/or
that the UE is a device comprising a mains-independent power source, and
wherein, responsive to the received information, the base station is to consider the information received for coordinating a communication of the UE and/or for controlling an operation of the UE.

42. The base station of claim 41, wherein, responsive to the received information, the base station is to adapt one or more of the following:
a scheduling, e.g., how frequently a wake-up signal or a paging is transmitted to the UE,
conveying of control information based on which search spaces, e.g., control resource sets, CORESETs, are expected to be monitored by the UE,
configuring the operations accordingly, e.g. configure the UE with less blind decoding attempts to make the UE last longer,
configuring configured grants,
configuring or scheduling sidelink resources, e.g., resource pools,
sensing modes,
grants

43. The base station of claim 41, wherein, responsive to the received information, the base station is to adapt one or more of the following operational procedures performed by the UE:
a Discontinuous Reception, DRX, procedure,
a paging procedure,
a control channel monitoring procedure, like a Physical Downlink Control Channel, PDCCH, or a Physical Sidelink Control Channel, PSCCH,
a measurement procedure.

44. The base station of claim 43, wherein the base station is to perform one or more of the following:
receive from the UE a report of the one or more criteria, determine a minimum control channel monitoring capability, and signal the determined minimum control channel monitoring capability to the UE,
receive from the UE a signaling indicating that the UE is to recover energy, determine a control channel skipping configuration or one or more new search spaces to be monitored for control channel monitoring occasions, and signal the control channel skipping configuration or the new search space to the UE, thereby giving the UE time to recharge,
receive from the UE a report which specifies which measurements the UE is able to perform further and/or which measurements the UE is not able to perform further at a current condition of the energy storage device, and determine and forward to the UE one or more of the following:
a list of measurements and/or reports to be activated and/or deactivated,
a list of relaxation measures, like a reduced frequency of measurements and/or reports,
for one or some or all types of measurements an individual new measurement configuration.

45. The base station of claim 41, wherein the base station is to serve one or more energy harvesting user devices, UEs, wherein the energy harvesting UE comprises an energy storage device for a signal processor of the UE to provide power to the signal processor for performing one or more operations, and an energy harvesting device for charging the energy storage device without the need to connect the energy storage device to an external charging device.

46. The base station of claim 41, wherein the UE comprise a user device, UE, for a wireless communication system, comprising:
one or more antennas,
a signal processor connected to the antenna, wherein the signal processor is to perform one or more operations, and
a mains-independent power source connected to the signal processor to provide power to the signal processor for performing the one or more operations,
wherein the UE is to
signal to one or more entities of the wireless communication system information indicating
a status of the mains-independent power source, and/or
that the UE is a device comprising a mains-independent power source, and/or
adapt one or more of operational procedures dependent on a status of the mains-independent power source.

47. A wireless communication system, comprising one or more user devices, UEs, of claim 1 and/or one or more base stations for a wireless communication system,
wherein the base station is to serve one or more user devices, UEs, wherein the UE comprises a mains-independent power source for a signal processor of the UE to provide power to the signal processor for performing one or more operations,
wherein the base station is to receive from the UE information indicating
a status of the mains-independent power source, and/or
that the UE is a device comprising a mains-independent power source, and
wherein, responsive to the received information, the base station is to consider the information received for coordinating a communication of the UE and/or for controlling an operation of the UE.

48. The user device, UE, of claim 47, wherein the UE comprise one or more of the following: a power-limited UE, or an energy-harvesting UE or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

49. The wireless communication system of claim 47, wherein the base station comprises one or more of the following: a macro cell base station, or a small cell base station, or a central unit of a base station, or a distributed unit of a base station, or an Integrated Access and Backhaul, IAB, node, or a road side unit, RSU, or a UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

50. A method for operating a user device, UE, for a wireless communication system, the UE comprising one or more antennas, a signal processor connected to the antenna, wherein the signal processor is to perform one or more operations, and a mains-independent power source connected to the signal processor to provide power to the signal processor for performing the one or more operations, the method comprising:
signaling, by the UE, to one or more entities of the wireless communication system information indicating
a status of the mains-independent power source, and/or
that the UE is a device comprising a mains-independent power source, and/or
adapting, by the UE, one or more of operational procedures dependent on a status of the mains-independent power source.

51. A method for operating a base station for a wireless communication system, comprising:
serving one or more user devices, UEs, wherein the UE comprises a mains-independent power source for a signal processor of the UE to provide power to the signal processor for performing one or more operations,
receiving from the UE information indicating
a status of the mains-independent power source, and/or
that the UE is a device comprising a mains-independent power source, and
responsive to the received information, considering the information received for coordinating a communication of the UE and/or for controlling an operation of the UE.

52. A non-transitory digital storage medium having stored thereon a computer program for performing a method for operating a user device, UE, for a wireless communication system, the UE comprising one or more antennas, a signal processor connected to the antenna, wherein the signal processor is to perform one or more operations, and a mains-independent power source connected to the signal processor to provide power to the signal processor for performing the one or more operations, the method comprising:
signaling, by the UE, to one or more entities of the wireless communication system information indicating
a status of the mains-independent power source, and/or
that the UE is a device comprising a mains-independent power source, and/or
adapting, by the UE, one or more of operational procedures dependent on a status of the mains-independent power source,
when the computer program is run by a computer.

53. A non-transitory digital storage medium having stored thereon a computer program for performing a method for operating a base station for a wireless communication system, comprising:
serving one or more user devices, UEs, wherein the UE comprises a mains-independent power source for a signal processor of the UE to provide power to the signal processor for performing one or more operations,
receiving from the UE information indicating
a status of the mains-independent power source, and/or
that the UE is a device comprising a mains-independent power source, and
responsive to the received information, considering the information received for coordinating a communication of the UE and/or for controlling an operation of the UE,
when the computer program is run by a computer.
